(19) United States
(12) Patent Application Publication
(10) Pub. No.: US 2018/0031290 A1
(43) Pub. Date: Feb. 1, 2018

(54) VAPOR CYCLE REFRIGERATION SYSTEM FILTER LIFE ESTIMATION

(71) Applicant: Hamilton Sundstrand Corporation, Windsor Locks, CT (US)

(72) Inventors: Tony Ho, Glastonbury, CT (US); Young K. Park, Simsbury, CT (US)

(21) Appl. No.: 15/222,445

(22) Filed: Jul. 28, 2016

(51) Int. Cl. F25B 49/02; F25B 43/00; B64D 13/08

(52) U.S. Cl. CPC F25B 49/02; B64D 13/08; F25B 43/003; B64D 2013/0651

(57) ABSTRACT

Operational parameters of an aircraft vapor cycle refrigeration system are measured via a plurality of sensors while the vapor cycle refrigeration system is operating. The measured operational parameters are transmitted to a computer system. The computer system generates, using a first reduced order model corresponding to an unclogged state of a filter of the vapor cycle refrigeration system, a first predicted discharge pressure of a compressor based on the measured operational parameters. The computer system generates, using a second reduced order model that corresponds to a clogged state of the filter, a second predicted discharge pressure of the compressor based on the measured operational parameters. The computer system determines a remaining useful life of the filter based on the first predicted discharge pressure, the second predicted discharge pressure, and a measured discharge pressure of the compressor. The computer system outputs an indication of the remaining useful life of the filter.

### BACKGROUND

The present disclosure relates generally to vapor cycle refrigeration systems, and in particular to determining a remaining useful life of a filter of a vapor cycle refrigeration system using reduced order modeling techniques.

Complex systems, such as those implemented onboard aircraft, often include operational parameters that may not be sensed by physical sensors of the system. For example, aircraft air-conditioning packs implementing vapor cycle refrigeration techniques may not have sensor readings to measure parameters such as a differential pressure across system filters. Knowledge of these unmeasured parameters can be useful for protective control modes, system health diagnostics, and planned maintenance activities. It may be possible to sense these parameters with physical sensors, but at added cost, complexity, and weight to the system.

### SUMMARY

In one example, a method includes operating a vapor cycle refrigeration system of an aircraft. The method further includes measuring, via a plurality of sensors, operational parameters of the vapor cycle refrigeration system while the vapor cycle refrigeration system is operating, and transmitting the measured operational parameters to a computer system. The method further includes generating, by the computer system using a first reduced order model that corresponds to an unclogged state of a filter of the aircraft vapor cycle refrigeration system, a first predicted discharge pressure of a compressor of the aircraft vapor cycle refrigeration system based on the measured operational parameters. The method further includes generating, by the computer system using a second reduced order model that corresponds to a clogged state of the filter, a second predicted discharge pressure of the compressor based on the measured operational parameters. The method further includes determining, by the computer system, a remaining useful life of the filter based on the first predicted discharge pressure, the second predicted discharge pressure, and a measured discharge pressure of the compressor, and outputting, by the computer system, an indication of the remaining useful life of the filter.

In another example, a system includes a vapor cycle refrigeration system of an aircraft and a computer system. The vapor cycle refrigeration system includes a plurality of sensors, a compressor, and a filter. The plurality of sensors are configured to measure operational parameters of the vapor cycle refrigeration system. The compressor is configured to compress refrigerant of the vapor cycle refrigeration system. The filter is disposed within a flow path of the refrigerant. The computer system includes at least one processor and computer-readable memory. The computer-readable memory is encoded with instructions that, when executed by the at least one processor, cause the computer system to receive the operational parameters of the vapor cycle refrigeration system measured by the plurality of sensors, and generate, using a first reduced order model that corresponds to an unclogged state of the filter, a first predicted discharge pressure of the compressor based on the received operational parameters. The computer-readable memory is further encoded with instructions that, when executed by the at least one processor, cause the computer system to generate, using a second reduced order model that corresponds to a clogged state of the filter, a second predicted discharge pressure of the compressor based on the received operational parameters. The computer-readable memory is further encoded with instructions that, when executed by the at least one processor, cause the computer system to determine a remaining useful life of the filter based on the first predicted discharge pressure, the second predicted discharge pressure, and a measured discharge pressure of the compressor. The computer-readable memory is further encoded with instructions that, when executed by the at least one processor, cause the computer system to output an indication of the remaining useful life of the filter.

### BRIEF DESCRIPTION OF THE DRAWINGS

FIG. 1 is a schematic block diagram illustrating an example system including an aircraft vapor cycle refrigeration system and a computer system that determines a remaining useful life of a filter of the vapor cycle refrigeration system using reduced order models.

FIG. 2 is a flow diagram illustrating example operations to generate a reduced order model that can be utilized to determine a remaining useful life of a filter of a vapor cycle refrigeration system.

FIG. 3 is a flow diagram illustrating example operations to determine a remaining useful life of a filter of a vapor cycle refrigeration system using reduced order models.

### DETAILED DESCRIPTION

As described herein, a computer system utilizes reduced order modeling techniques to determine a remaining useful life of a filter of an aircraft vapor cycle refrigeration system. The filter, disposed within a flow path of refrigerant of the system, gathers debris and particles that may be generated during normal system operation. Accordingly, the filter helps to prevent circulation of the debris that could eventually cause evaporator fouling, throttling valve clogging, or compressor damage. However, as the filter collects debris, its impedance of the flow of refrigerant increases. This increased impedance in turn causes a system compressor to increase the refrigerant pressure to overcome the filter impedance. A compressor discharge pressure that exceeds a maximum protective threshold pressure can cause the compressor to shutdown (i.e., halt operation) to prevent damage to the compressor or other system components. As such, replacement (or cleaning) of the filter prior to system shutdown is desirable to prevent inoperability of the cooling system and the corresponding loss of service and revenue from, e.g., commercial flights.

According to techniques of this disclosure, a computer system utilizes reduced order models to generate predicted discharge pressures of a compressor, the predicted discharge pressures corresponding to both clogged and unclogged states of the filter. The computer system determines a remaining useful life (RUL) of the filter based on the predicted discharge pressures and a measured discharge pressure of the compressor. The computer system outputs an indication of the RUL of the filter including, e.g., a percentage of filtering capacity remaining prior to reaching a clogged filter state that can result in compressor shutdown, an indication of a remaining system runtime prior to reaching the clogged filter state, or other indications of RUL of the filter. As such, the system can determine a RUL of the filter without requiring dedicated pressure or other sensors, such as a differential pressure sensor (or multiple pressure sensors) for measuring a difference in pressure of the refrigerant across the filter. The use of predicted pressures generated by the reduced order models enables the computer system to account for relatively high refrigerant pressures that may be due to normal system operation, rather than clogging of the filter. Moreover, the reduced order of the models (as compared to a higher-fidelity model) lowers the computational complexity of the models, thereby decreasing runtime of the models, requirements of the computer, and complexity of model implementation.

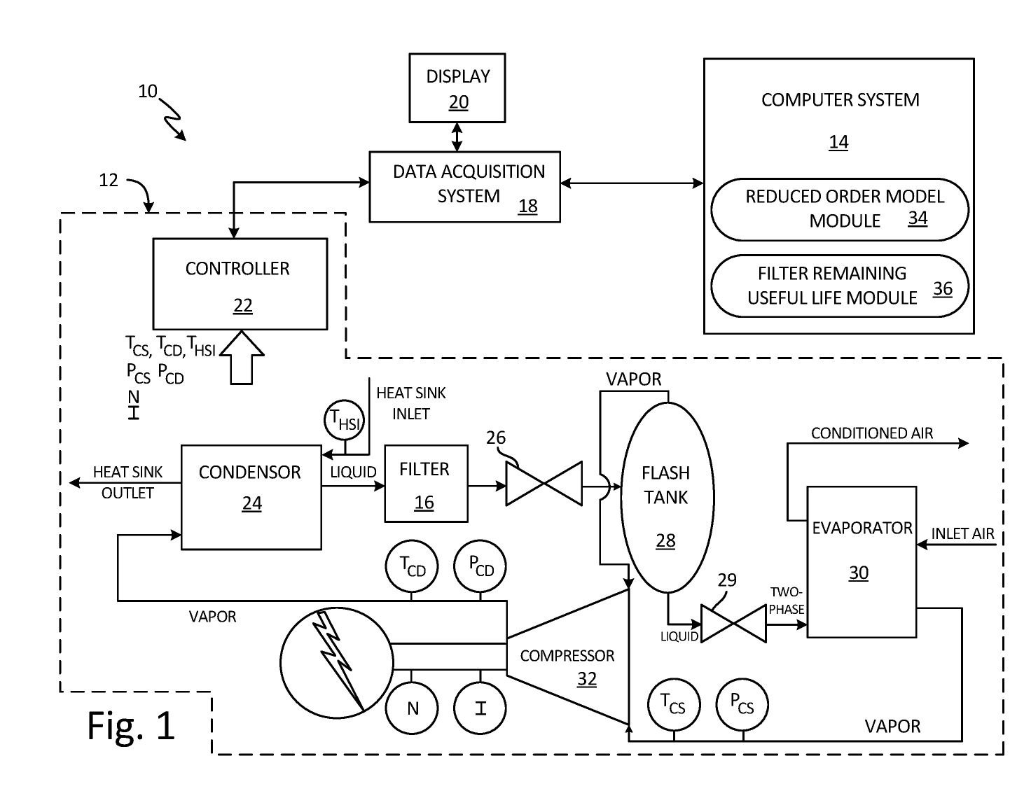

FIG. 1 is a schematic block diagram illustrating system 10 that includes aircraft vapor cycle refrigeration system 12 and computer system 14 that determines a remaining useful life (RUL) of filter 16 using reduced order models. As illustrated in FIG. 1, system 10 further includes data acquisition system 18 and display 20. Vapor cycle refrigeration system 12 includes controller 22, condenser 24, expansion orifice 26, flash tank 28, throttling valve 29, evaporator 30, compressor 32, heat sink inlet temperature sensor T_{HSI}, compressor suction temperature sensor T_{CS}, compressor suction pressure sensor P_{CS}, compressor discharge temperature sensor T_{CD}, compressor discharge pressure sensor P_{CD}, compressor speed sensor N, and compressor motor current sensor I. Computer system 14 includes reduced order model (ROM) module 34 and filter RUL module 36. The arrowed lines extending between condenser 24, filter 16, expansion orifice 26, flash tank 28, throttling valve 29, evaporator 30, and compressor 32 indicate a flow and direction of refrigerant circulated in vapor cycle refrigeration system 12.

Refrigerant is supplied to compressor 32 in vapor form from both flash tank 28 and evaporator 30. Compressor 32 compresses the refrigerant to a higher pressure and supplies the compressed refrigerant in vapor form to condenser 24. Condenser 24 condenses the compressed vapor refrigerant to liquid form using cooling liquid and/or gaseous flow supplied through the heat sink inlet. Heat from the compressed refrigerant is transferred from the refrigerant to the cooling liquid and/or gaseous flow supplied to condenser 24 through the heat sink inlet and is carried away from vapor cycle refrigeration system 12 via the heat sink outlet. The condensed, liquid refrigerant is supplied from condenser 24 through filter 16 to expansion orifice 26. Filter 16 is disposed within a flow path of the refrigerant and includes filter media, such as fibrous filter media sized to trap particles and other debris that may be present within the liquid refrigerant while allowing the liquid refrigerant to pass through the media. While in the example of FIG. 1, filter 16 is disposed downstream of condenser 24 and upstream of expansion orifice 26, filter 16 can be disposed in any location of vapor cycle refrigeration system 12 in which refrigerant is conveyed in liquid form, such as downstream of flash tank 28 and upstream of throttling valve 29.

Condensed liquid refrigerant passed through filter 16 is supplied through expansion orifice 26. As the liquid refrigerant passes through expansion orifice 26, a rapid pressure reduction of the liquid refrigerant occurs causing an evaporation of a portion of the refrigerant and resulting in two-phase refrigerant (i.e., liquid phase and vapor phase) that is supplied to flash tank 28 where phase separation occurs through, e.g., gravity separation. Expansion orifice 26 can be a fixed orifice configured to cause the pressure reduction in the refrigerant. In some examples, expansion orifice 26 can be implemented as a valve, the position of which is controlled via, e.g., controller 22 to cause and/or control the pressure reduction of the refrigerant.

Vapor-form refrigerant is supplied from flash tank 28 to compressor 32. Liquid refrigerant, cooled by both the heat transfer in condenser 24 and the rapid pressure reduction through expansion orifice 26, is supplied to throttling valve 29. A position of throttling valve 29, sometimes referred to as an expansion valve, is controlled by a motor (not illustrated) via commands from controller 22 to cause a rapid pressure reduction of the liquid refrigerant as it passes through throttling valve 29, thereby causing an evaporation of a portion of the refrigerant (having a further cooling effect on the refrigerant) and resulting in a two-phase refrigerant (i.e., liquid phase and vapor phase) that is supplied to evaporator 30.

Evaporator 30 cools inlet air as it is passed through evaporator 30 through an evaporation process in which the liquid refrigerant is converted (i.e., evaporated) from the liquid state to a mostly or entirely gaseous state. The evaporation process absorbs heat from the inlet air, thereby cooling the inlet air and providing conditioned air for, e.g., a cabin, galley, or other air conditioning system. The evaporated refrigerant is supplied from evaporator 30 to compressor 32. As such, vapor cycle refrigeration system 12 provides a closed-loop cycle of refrigerant in which heat is transferred from an inlet air supply to the refrigerant to provide cooled, conditioned air, and rejected from vapor cycle refrigeration system 12 via the heat sink inlet and the heat sink outlet at condenser 24.

As liquid refrigerant passes through filter 16, particles or other debris that may be present in the refrigerant (e.g., created during normal operation of system components) are collected within the filtration media of filter 16. As filter 16 begins to clog with particles, the impedance of filter 16 to flow of the refrigerant increases. In response, compressor 32 increases the discharge pressure to maintain operational pressures of the refrigerant downstream of filter 16. Compressor 32 and/or controller 22, however, maintain the discharge pressure of compressor 32 to a pressure that is below a maximum threshold pressure to prevent physical damage to compressor 32 and/or other components of vapor cycle refrigeration system 12 that could occur at refrigerant pressures above the maximum threshold pressure.

As illustrated in FIG. 1, vapor cycle refrigeration system includes controller 22. Controller 22 can be any electronic device that is operationally coupled (e.g., electrically and/or communicatively coupled) to components of vapor cycle refrigeration system 12 to control real-time operation of the components of the system and to receive inputs from various sensors positioned throughout vapor cycle refrigeration system 12. As illustrated in FIG. 1, controller 22 is operationally connected to receive inputs from compressor suction temperature sensor T_{CS}, compressor discharge temperature sensor T_{CD}, heat sink inlet temperature sensor T_{HSI}, compressor suction pressure sensor P_{CS}, compressor discharge pressure sensor P_{CD}, compressor speed sensor N, and compressor motor current sensor I.

Compressor suction temperature sensor T_{CS} and compressor suction pressure sensor P_{CS} are positioned at or near an upstream inlet of compressor 32 to measure a temperature and pressure of refrigerant entering the upstream (or suction) inlet of compressor 32. Compressor discharge temperature sensor T_{CD} and compressor discharge pressure sensor P_{CD} are positioned at or near a downstream outlet of compressor 32 to measure a temperature and pressure of refrigerant exiting the downstream (or discharge) outlet of compressor 32. Compressor speed sensor N and compressor current sensor I are integral to or positioned adjacent to compressor 32. Compressor speed sensor N is configured to sense an operational speed of compressor 32, such as a rotational speed of a shaft of compressor 32. Compressor current sensor I is configured to sense an amount of electrical current draw of compressor 32 from a power source integral to or remote from vapor cycle refrigeration system 12. Heat sink inlet temperature sensor T_{HSI} is positioned at or near the heat sink inlet of condenser 24 to sense a temperature of the cooling liquid and/or gaseous flow through the heat sink inlet.

As further illustrated in FIG. 1, system 10 includes data acquisition system 18, display 20, and computer system 14. Data acquisition system 18 includes one or more electronic components configured to receive various discrete, analog, and/or digital parameters from sensors and/or systems of an aircraft that includes system 10 and distribute the received parameters to consuming systems. Display 20 can be a display device positioned in, e.g., a cockpit of the aircraft. In some examples, display 20 can include one or more input devices, such as buttons or touch-sensitive components to receive input from a user (e.g., user confirmation or acknowledgments of displayed data). Computer system 14 can be a remote, ground-based computer system or a computer system of an aircraft that includes system 10. For example, computer system 14 can be part of a ground-based maintenance system that receives aircraft operational data and processes the data for diagnostic or other maintenance activities. In other examples, computer system 14 can be part of an on-board avionics system, such as an aircraft prognostics and health management system.

Controller 22, as illustrated in FIG. 1, is communicatively coupled to data acquisition system 18 via one or more wired or wireless communication channels, or both. For example, controller 22 can be connected to data acquisition system 18 via an aircraft data bus implementing the Aeronautical Radio, Inc. (ARINC) 429 or other communication protocol. Data acquisition system 18 is communicatively coupled to display 20 (e.g., via the ARINC 429 data bus or other communication channels) to transmit data that is displayed at display 20 and/or receive data (e.g., user input data) from display 20. Data acquisition system 18 is communicatively coupled with computer system 14 via one or more wired and/or wireless communication channels. For instance, in examples where computer system 14 is a ground-based computer system, data acquisition system 18 can be communicatively coupled with computer system 14 via one or more wireless communication channels, such as cellular communications, wireless Internet communications (e.g., WiFi), or other wireless communication channels.

Each of computer system 14 and controller 22 include one or more processors and computer-readable memory encoded with instructions that, when executed by the one or more processors, cause computer system 14 and controller 22 to operate in accordance with techniques described herein. Examples of the one or more processors include any one or more of a microprocessor, a controller, a digital signal processor (DSP), an application specific integrated circuit (ASIC), a field-programmable gate array (FPGA), or other equivalent discrete or integrated logic circuitry. Computer-readable memory of computer system 14 and controller 22 can be configured to store information with computer system 14 and controller 22 during operation. The computer-readable memory can be described, in some examples, as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). Computer-readable memory of computer system 14 and controller 22 can include volatile and non-volatile memories. Examples of volatile memories can include random access memories (RAM), dynamic random access memories (DRAM), static random access memories (SRAM), and other forms of volatile memories Examples of non-volatile memories can include magnetic hard discs, optical discs, floppy discs, flash memories, or forms of electrically programmable memories (EPROM) or electrically erasable and programmable (EEPROM) memories.

Computer system 14, as illustrated in FIG. 1, includes ROM module 34 and filter RUL module 36. As described herein, computer system 14 utilizes ROM module 34 to generate predicted discharge pressures of compressor 32 corresponding to an unclogged state of filter 16 and a clogged state of filter 16. Computer system 14 utilizes filter RUL module 36 to determine a remaining useful life of filter 16 based on the predicted discharge pressures from ROM module 34 and a measured discharge pressure sensed by compressor discharge pressure sensor P_{CD}.

The reduced order models utilized by ROM module 34 can be generated based on a high-fidelity physics-based model of vapor cycle refrigeration system 12 or operational data captured during operation of vapor cycle refrigeration system 12 (e.g., test data), as is further described below. ROM module 34 can utilize a first reduced order model that is adapted to generate a first predicted discharge pressure of compressor 32 corresponding to an unclogged state of filter 16 based on a set of measured input parameters of vapor cycle refrigeration system 12. ROM module 34 can utilize a second reduced order model that is adapted to generate a second predicted discharge pressure of compressor 32 corresponding to a clogged state of filter 16 based on the set of measured input parameters of vapor cycle refrigeration system 12. Each of the first and second reduced order models can be implemented using the following equation:

P_{pred}=b₀+Σᵢbᵢxᵢ^{c}^{ᵢ}+Σⱼbⱼ(X)ⱼ^{c}^{ⱼ} Equation (1)

where:
P_{pred} is a predicted discharge pressure of the compressor (i.e., the first predicted discharge pressure corresponding to the unclogged state of filter 16 or the second predicted discharge pressure corresponding to the clogged state of filter 16);
b₀ is a constant;
bᵢ and bⱼ are multiplicative regression coefficients;
cᵢ and cⱼ are exponential regression coefficients;
xᵢ are first order parameters, each corresponding to one of the set of measured input operational parameters; and
Xⱼ are interaction terms, each corresponding to a multiplicative product of two or more of the measured input operational parameters.

ROM module 34 can receive a set of measured input parameters from one or more of compressor suction temperature sensor T_{CS}, compressor discharge temperature sensor T_{CD}, heat sink inlet temperature sensor T_{HSI}, compressor suction pressure sensor P_{CS}, compressor discharge pressure sensor P_{CD}, compressor speed sensor N, and compressor current sensor I. ROM module 34 can determine the first predicted discharge pressure of compressor 32 corresponding to the unclogged state of filter 16 using Equation (1) having constant b₀, multiplicative regression coefficients bᵢ and bⱼ, and exponential regression coefficients cᵢ and cⱼ that are configured to produce a predicted pressure P_{pred} that estimates a discharge pressure of compressor 32 during operation of vapor cycle refrigeration system 12 having an unclogged state of filter 16. ROM module 34 can determine the second predicted discharge pressure of compressor 32 corresponding to the clogged state of filter 16 using Equation (1) having constant b₀, multiplicative regression coefficients bᵢ and bⱼ, and exponential regression coefficients cᵢ and cⱼ that are configured to produce a predicted pressure P_{pred} that estimates a discharge pressure of compressor 32 during operation of vapor cycle refrigeration system 12 having a clogged state of filter 16.

Filter RUL module 36 utilizes the first predicted discharge pressure corresponding to the unclogged state of filter 16, the second predicted discharge pressure corresponding to the clogged state of filter 16, and a measured pressure from compressor discharge pressure sensor P_{CD} to determine a remaining useful life of filter 16. For example, RUL module 36 can determine the remaining useful life of filter 16 using the following equation:

$${Filter}_{life} = min ( 1 , 1 - \frac{{P}_{dis} - {P}_{disClean}}{{P}_{disClogged} - {P}_{disClean}} ) \times 100 \% \qquad Equation ( 2 )$$

where:
Filter_{life} is the remaining useful life of the filter;
P_{dis} is the measured discharge pressure received from compressor discharge pressure sensor P_{CD};
P_{disClean} is the first predicted discharge pressure corresponding to the unclogged state of filter 16;
P_{disClogged} is the second predicted discharge pressure corresponding to the clogged state of filter 16; and
the min operator selects the minimum value of the two operands.

Computer system 14 can output an indication of the remaining useful life of filter 16, such as to a display device of computer system 14 (not illustrated), data acquisition system 18, or other consuming system. While Equation (2) above is adapted to produce a remaining useful life of filter 16 that is expressed as a percentage of filtering capacity of filter 16 remaining prior to reaching a clogged filter state that can result in protective shutdown of compressor 32, in some examples, the remaining useful life of filter 16 output by computer system 14 can include other indications of the remaining useful life. For instance, RUL module 36 can determine an estimated remaining runtime of vapor cycle refrigeration system 12 prior to reaching the clogged state of filter 16 based on a runtime of vapor cycle refrigeration system 12 since installation (or cleaning) of filter 16 and the determined percentage of filtering capacity of filter 16 remaining prior to reaching the clogged filter state.

In operation, computer system 14 transmits a data upload request to data acquisition system 18 to request an upload of measured operational parameters of vapor cycle refrigeration system 12 during operation of vapor cycle refrigeration system 12. The upload request can be periodic, such as on a per-flight basis, a per-runtime basis, or other periods. Data acquisition system 18, in response to receiving the data upload request, retrieves measured operational parameters of vapor cycle refrigeration system 12 from controller 22 and transmits the received parameters to computer system 14. The measured operational parameters can include, e.g., measured parameters from compressor suction temperature sensor T_{CS}, compressor discharge temperature sensor T_{CD}, heat sink inlet temperature sensor T_{HSI}, compressor suction pressure sensor P_{CS}, compressor discharge pressure sensor P_{CD}, compressor speed sensor N, and compressor current sensor I.

ROM module 34 determines a first predicted discharge pressure of compressor 32 based on the measured operational parameters using a first reduced order model that corresponds to an unclogged state of filter 16. ROM module 23 determines a second predicted discharge pressure of compressor 32 based on the measured operational parameters using a second reduced order model that corresponds to a clogged state of filter 16. Filter RUL module 36 determines a remaining useful life of filter 16 based on the first predicted discharge pressure, the second predicted discharge pressure, and a measured discharge pressure sensed by compressor discharge pressure sensor P_{CD}.

Computer system 14 outputs an indication of the remaining useful life of filter 16, such as to a display of computer system 14 (e.g., for use by maintenance personnel), data acquisition system 18 (e.g., for further transmission to an aircraft prognostics and health management system), or to one or more other consuming systems. As such, system 10 implementing techniques of this disclosure determines a remaining useful life of filter 16 that can be monitored over time to enable maintenance personnel and/or prognostic systems to predict (and plan for) maintenance of filter 16 prior to a degree of clogging of filter 16 that could result in inoperability of vapor cycle refrigeration system 12.

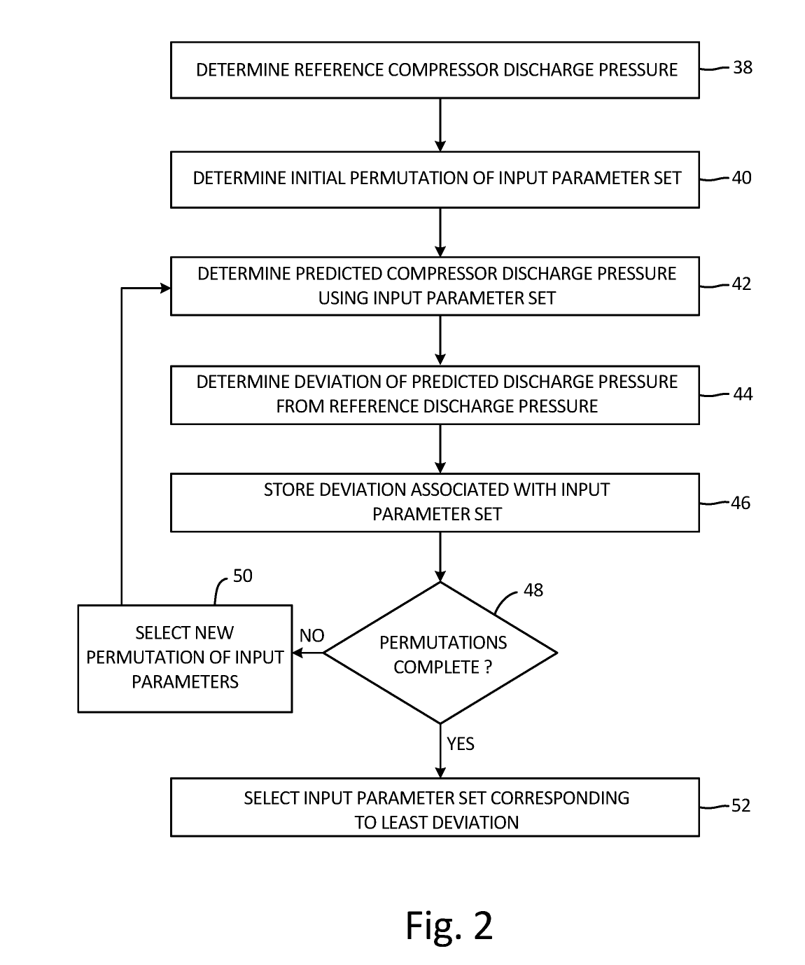

FIG. 2 is a flow diagram illustrating example operations to generate a reduced order model that can be utilized to determine a remaining useful life of a filter of a vapor cycle refrigeration system. For purposes of clarity and ease of discussion, the example operations are described below within the context of system 10 of FIG. 1. While described with respect to the generation of a single reduced order model, the example operations of FIG. 2 can be used by ROM module 34 to generate multiple reduced order models corresponding to multiple operational states of filter 16, such as an unclogged state of filter 16, a clogged state of filter 16, or other defined states of filter 16.

A reference discharge pressure for compressor 32 of vapor cycle refrigeration system 12 which the reduced order models will try to predict is generated and collected (Step 38) via methods such as high fidelity modeling results and/or laboratory or field test data collection. The reference discharge pressure of compressor 32 is determined for a selected state of filter 16, such as one of an unclogged state and a clogged state of filter 16. The unclogged state of filter 16 corresponds to an operational state and corresponding impedance to flow of refrigerant in which filter 16 contains substantially only filter media without foreign debris. The clogged state of filter 16 corresponds to an operational state in which filter 16 exhibits an impedance to refrigerant flow that results in an operational discharge pressure of compressor 32 that is near or exceeds a predefined maximum protective threshold pressure. In some examples, computer system 14 can determine the reference discharge pressure of compressor 32 over an operational envelope of vapor cycle refrigeration system 12 using a high-fidelity physics-based model that simulates operational parameters of each component of vapor cycle refrigeration system 12. In another example, computer system 14 can determine a reference discharge pressure of compressor 32 using stored operational parameters of vapor cycle refrigeration 12 that were stored during previous operation of vapor cycle refrigeration cycle 12 with the corresponding state of filter 16 during, for example, test data collection in the field or laboratory (e.g., an unclogged state, a clogged state, or other states of filter 16).

An initial permutation of input parameters is determined (Step 40). For example, a first permutation of input parameters xᵢ and interaction terms Xⱼ from Equation (1) can be determined. A predicted compressor discharge pressure of compressor 32 is generated using Equation (1) and the selected set of input parameters (Step 42). For instance, ROM module 34 can generate predicted compressor discharge pressure P_{pred} using Equation (1) with the selected set (e.g., the first permutation) of input parameters xᵢ and terms Xⱼ. The deviation of interaction the determined predicted discharge pressure of compressor 32 from the reference discharge pressure is determined (Step 44). For example, ROM module 34 can determine the difference between the predicted discharge pressure P_{pred} and the reference discharge pressure collected via high fidelity modeling results or laboratory test data collection corresponding to the selected state of filter 16 (e.g., one of the unclogged or clogged state of filter 16). The deviation of the predicted discharge pressure from the collected reference discharge pressure is associated with the selected permutation of input parameters and stored in computer-readable memory of computer system 14 (Step 46).

Computer system 14 determines whether each permutation of input parameters has been selected (Step 48). In response to determining that at least one permutation of input parameters has not been selected (“NO” branch of 48), computer system 14 selects a new permutation of the set of input parameters (Step 50) and determines a predicted discharge pressure P_{pred} of compressor 32 using the new permutation of input parameters (Step 42). In response to determining that each permutation of input parameters has been selected (“YES” branch of 48), computer system 14 selects the input parameter set corresponding to the least deviation from the reference discharge pressure (Step 52). For example, computer system 14 can select the least deviation from the set of stored deviations of predicted discharge pressures from the reference discharge pressure. Computer system 14 can select the associated permutation of input parameters as the set of input parameters that are used for the reduced order model to determine the predicted discharge pressure corresponding to the selected state of filter 16. As such, computer system 14 can determine the set of input parameters from among the set of possible input parameters that produce a least deviation from the reference discharge pressure.

In another embodiment, an initial statistical test is first conducted to determine which input parameters xᵢ and interaction terms Xⱼ from Equation (1) show the greatest sensitivity and correlation to the reference discharge pressure. Input parameters and interaction terms that do not pass the statistical test are omitted from Equation (1) and not used further. An optimizer is then use to determine the regression coefficients to give the best fit to the reference discharge pressure in Equation (1).

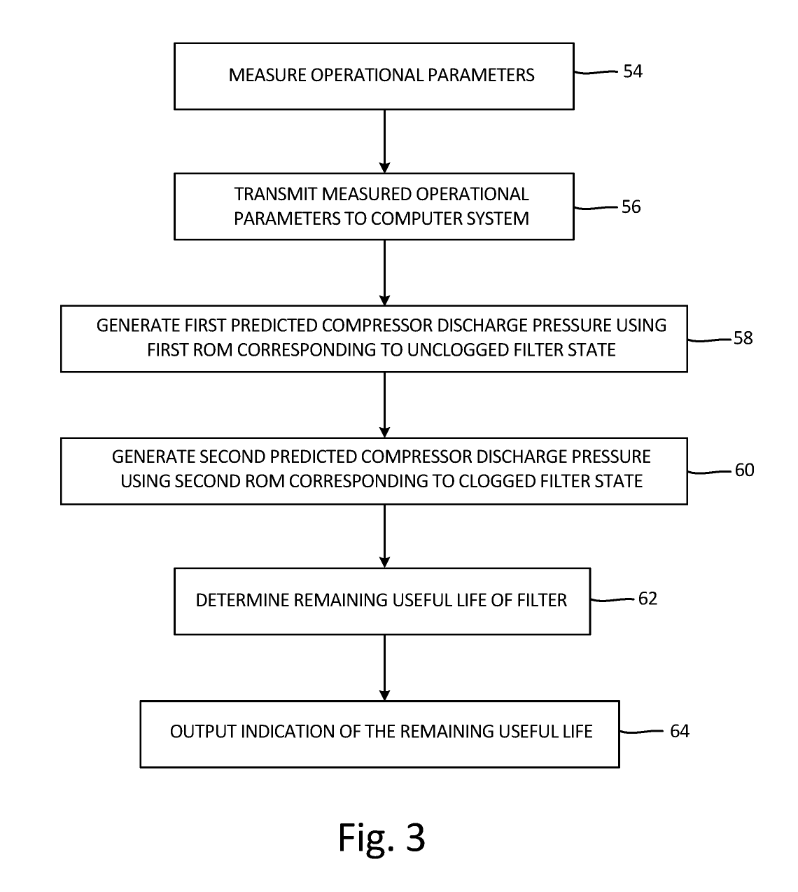

FIG. 3 is a flow diagram illustrating example operations to determine a remaining useful life of a filter of a vapor cycle refrigeration system using reduced order models. For purposes of clarity and ease of discussion, the example operations are described below within the context of system 10 of FIG. 1. Operational parameters of vapor cycle refrigeration system 12 are measured via a plurality of sensors while vapor cycle refrigeration system 12 is operating (Step 54). For example, compressor suction temperature sensor T_{CS}, compressor discharge temperature sensor T_{CD}, heat sink inlet temperature sensor T_{HSI}, compressor suction pressure sensor P_{CS}, compressor discharge pressure sensor P_{CD}, compressor speed sensor N, and compressor motor current sensor I can measure operational parameters of vapor cycle refrigeration system 12 during operation of vapor cycle refrigeration system 12. The measured operational parameters are transmitted to computer system 14 (Step 56). For instance, data acquisition system 18 can transmit a data upload request to controller 22 to request the transmission of the operational parameters from controller 22 to data acquisition system 18. Controller 22 can transmit the operational parameters sensed by compressor suction temperature sensor T_{CS}, compressor discharge temperature sensor T_{CD}, heat sink inlet temperature sensor T_{HSI}, compressor suction pressure sensor P_{CS}, compressor discharge pressure sensor P_{CD}, compressor speed sensor N, and compressor motor current sensor I to data acquisition system 18 in response to receiving the data upload request. Data acquisition system 18 can transmit the measured operational parameters to computer system 14 via, e.g., one or more wired and/or wireless communication channels.

ROM module 34 generates, using a first reduced order model that corresponds to an unclogged state of filter 16, a first predicted discharge pressure of compressor 32 based on the measured operational parameters (Step 58). ROM module 34 generates, using a second reduced order model that corresponds to a clogged state of filter 16, a second predicted discharge pressure of compressor 32 based on the measured operational parameters (Step 60). Filter RUL module 36 determines a remaining useful life of filter 16 based on the first predicted discharge pressure, the second predicted discharge pressure, and a measured discharge pressure sensed by compressor discharge pressure sensor P_{CD} (Step 62). For example, filter RUL module 36 can determine the remaining useful life of filter 16 using Equation (2). Computer system 14 outputs an indication of the remaining useful life of filter 16 (Step 64).

Accordingly, system 10 implementing techniques of this disclosure determines a remaining useful life of filter 16 that can be monitored over time to enable maintenance personnel and/or prognostic systems to plan for maintenance of filter 16 prior to a level of clogging that could result in unplanned inoperability of vapor cycle refrigeration system 12.

### Discussion of Possible Embodiments

The following are non-exclusive descriptions of possible embodiments of the present invention.

A method includes operating a vapor cycle refrigeration system of an aircraft, measuring, via a plurality of sensors, operational parameters of the vapor cycle refrigeration system while the vapor cycle refrigeration system is operating, and transmitting the measured operational parameters to a computer system. The method further includes generating, by the computer system using a first reduced order model that corresponds to an unclogged state of a filter of the aircraft vapor cycle refrigeration system, a first predicted discharge pressure of a compressor of the aircraft vapor cycle refrigeration system based on the measured operational parameters. The method further includes generating, by the computer system using a second reduced order model that corresponds to a clogged state of the filter, a second predicted discharge pressure of the compressor based on the measured operational parameters. The method further includes determining, by the computer system, a remaining useful life of the filter based on the first predicted discharge pressure, the second predicted discharge pressure, and a measured discharge pressure of the compressor, and outputting, by the computer system, an indication of the remaining useful life of the filter.

The method of the preceding paragraph can optionally include, additionally and/or alternatively, any one or more of the following features, configurations, operations and/or additional components:

A further embodiment of the foregoing method, wherein determining the remaining useful life of the filter can include determining the remaining useful life of the filter according to the following equation:

$${Filter}_{life} = min ( 1 , 1 - \frac{{P}_{dis} - {P}_{disClean}}{{P}_{disClogged} - {P}_{disClean}} ) \times 100 \% ;$$

where: Filter_{life} is the remaining useful life of the filter; P_{dis} is the measured discharge pressure of the compressor; P_{disClean} is the first predicted discharge pressure of the compressor; and P_{disClogged} is the second predicted discharge pressure of the compressor.

A further embodiment of any of the foregoing methods, wherein each of the first reduced order model and the second reduced order model can be of the following form: P_{pred}=b₀+Σᵢbᵢxᵢ^{c}^{ᵢ}+Σⱼbⱼ(X)ⱼ^{c}^{ⱼ}; where: P_{pred} is a predicted discharge pressure of the compressor; b₀ is a constant; bᵢ and bⱼ are multiplicative regression coefficients; cᵢ and cⱼ are exponential regression coefficients; xᵢ are first order parameters, each corresponding to one of the measured operational parameters; and Xⱼ are interaction terms, each corresponding to a multiplicative product of two or more of the measured operational parameters.

A further embodiment of any of the foregoing methods, further comprising selecting the first order parameters xᵢ from a set of candidate first order parameters and selecting the interaction terms Xⱼ from a set of candidate interaction terms based on determining that the first order parameters xᵢ and the interaction terms Xⱼ result in the predicted discharge pressure P_{pred} that is within a threshold deviation from a reference discharge pressure of the compressor.

A further embodiment of any of the foregoing methods, further comprising: generating the first reduced order model using a high-fidelity physics-based model of the vapor cycle refrigeration system having a simulated unclogged state of the filter; and generating the second reduced order model using the high-fidelity physics-based model having a simulated clogged state of the filter.

A further embodiment of any of the foregoing methods, further comprising: generating the first reduced order model using first stored operational parameters of the vapor cycle refrigeration system that were stored during previous operation of the vapor cycle refrigeration system with the unclogged state of the filter; and generating the second reduced order model using second stored operational parameters of the vapor cycle refrigeration system that were stored during previous operation of the vapor cycle refrigeration system with the clogged state of the filter

A further embodiment of any of the foregoing methods, wherein computer system can be a remote, ground-based computer system.

A further embodiment of any of the foregoing methods, further comprising: receiving, by a controller device of the vapor cycle refrigeration system, a data upload request from a data acquisition system of an aircraft that includes the vapor cycle refrigeration system. Transmitting the plurality of measured operational parameters to the computer system can include: transmitting the plurality of measured operational parameters from the controller device of the vapor cycle refrigeration system to the data acquisition system in response to receiving the data upload request; and transmitting the plurality of measured operational parameters from the data acquisition system to the computer system.

A further embodiment of any of the foregoing methods, wherein the indication of the remaining useful life of the filter can include an indication of an estimated amount of remaining run-time of the vapor cycle refrigeration system before the remaining useful life of the filter reaches an unacceptable level.

A further embodiment of any of the foregoing methods, wherein the operational parameters include one or more of a compressor suction temperature, a compressor discharge temperature, a heat sink inlet temperature, a compressor suction pressure, a compressor discharge pressure, a compressor speed, and a compressor motor current draw.

A system includes a vapor cycle refrigeration system of an aircraft and a computer system. The vapor cycle refrigeration system includes a plurality of sensors, a compressor, and a filter. The plurality of sensors are configured to measure operational parameters of the vapor cycle refrigeration system. The compressor is configured to compress refrigerant of the vapor cycle refrigeration system. The filter is disposed within a flow path of the refrigerant. The computer system includes at least one processor and computer-readable memory. The computer-readable memory is encoded with instructions that, when executed by the at least one processor, cause the computer system to receive the operational parameters of the vapor cycle refrigeration system measured by the plurality of sensors, and generate, using a first reduced order model that corresponds to an unclogged state of the filter, a first predicted discharge pressure of the compressor based on the received operational parameters. The computer-readable memory is further encoded with instructions that, when executed by the at least one processor, cause the computer system to generate, using a second reduced order model that corresponds to a clogged state of the filter, a second predicted discharge pressure of the compressor based on the received operational parameters. The computer-readable memory is further encoded with instructions that, when executed by the at least one processor, cause the computer system to determine a remaining useful life of the filter based on the first predicted discharge pressure, the second predicted discharge pressure, and a measured discharge pressure of the compressor. The computer-readable memory is further encoded with instructions that, when executed by the at least one processor, cause the computer system to output an indication of the remaining useful life of the filter.

The system of the preceding paragraph can optionally include, additionally and/or alternatively, any one or more of the following features, configurations, operations and/or additional components:

A further embodiment of the foregoing system, wherein the computer system can be encoded with instructions that, when executed by the at least one processor, cause the computer system to determine the remaining useful life of the filter according to the following equation:

$${Filter}_{life} = min ( 1 , 1 - \frac{{P}_{dis} - {P}_{disClean}}{{P}_{disClogged} - {P}_{disClean}} ) \times 100 \% ;$$

where Filter_{life} is the remaining useful life of the filter; P_{dis} is the measured discharge pressure of the compressor; P_{disClean} is the first predicted discharge pressure of the compressor; and P_{disClogged} is the second predicted discharge pressure of the compressor.

A further embodiment of the foregoing system, wherein each of the first reduced order model and the second reduced order model can be of the following form: P_{pred}=b₀+Σᵢ bᵢxᵢ^{c}^{ᵢ}+Σⱼbⱼ(X)ᵢ^{c}^{ⱼ}; where: P_{pred} is a predicted discharge pressure of the compressor; b₀ is a constant; bᵢ and bⱼ are multiplicative regression coefficients; cᵢ and cⱼ are exponential regression coefficients; xᵢ are first order parameters, each corresponding to one of the measured operational parameters; and Xⱼ are interaction terms, each corresponding to a multiplicative product of two or more of the measured operational parameters.

A further embodiment of the foregoing system, wherein the computer-readable memory can be further encoded with instructions that, when executed by the at least one processor, cause the computer system to select the first order parameters xᵢ from a set of candidate first order parameters and select the interaction terms Xⱼ from a set of candidate interaction terms based on determining that the first order parameters xᵢ and the interaction terms Xⱼ result in the predicted discharge pressure Ppred that is within a threshold deviation from a reference discharge pressure of the compressor.

A further embodiment of the foregoing system, wherein the computer-readable memory can be further encoded with instructions that, when executed by the at least one processor, cause the computer system to: generate the first reduced order model using a high-fidelity physics-based model of the vapor cycle refrigeration system having a simulated unclogged state of the filter; and generate the second reduced order model using the high-fidelity physics-based model having a simulated clogged state of the filter.

A further embodiment of the foregoing system, wherein the computer-readable memory can be further encoded with instructions that, when executed by the at least one processor, cause the computer system to: generate the first reduced order model using first stored operational parameters of the vapor cycle refrigeration system that were stored during previous operation of the vapor cycle refrigeration system with the unclogged state of the filter; and generate the second reduced order model using second stored operational parameters of the vapor cycle refrigeration system that were stored during previous operation of the vapor cycle refrigeration system with the clogged state of the filter.

A further embodiment of the foregoing system, wherein the computer-system can be a remote, ground-based computer system.

A further embodiment of the foregoing system, wherein the vapor cycle refrigeration system can further include a controller device operatively connected to the plurality of sensors and to a data acquisition system of the aircraft. The controller device can be configured to transmit the operational parameters of the vapor cycle refrigeration system measured by the plurality of sensors to the data acquisition system in response to receiving a data upload request from the data acquisition system.

A further embodiment of the foregoing system, wherein the computer system can be further encoded with instructions that, when executed by the at least one processor, cause the computer system to determine an estimated amount of remaining run-time of the vapor cycle refrigeration system before the remaining useful life of the filter reaches an unacceptable level.

A further embodiment of the foregoing system, wherein the plurality of sensors can include one or more of a compressor suction temperature sensor, a compressor discharge temperature sensor, a heat sink inlet temperature sensor, a compressor suction pressure sensor, a compressor discharge pressure sensor, a compressor speed sensor, and a compressor motor current sensor.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method comprising:
operating a vapor cycle refrigeration system of an aircraft;
measuring, via a plurality of sensors, operational parameters of the vapor cycle refrigeration system while the vapor cycle refrigeration system is operating;
transmitting the measured operational parameters to a computer system;
generating, by the computer system using a first reduced order model that corresponds to an unclogged state of a filter of the aircraft vapor cycle refrigeration system, a first predicted discharge pressure of a compressor of the aircraft vapor cycle refrigeration system based on the measured operational parameters;
generating, by the computer system using a second reduced order model that corresponds to a clogged state of the filter, a second predicted discharge pressure of the compressor based on the measured operational parameters;
determining, by the computer system, a remaining useful life of the filter based on the first predicted discharge pressure, the second predicted discharge pressure, and a measured discharge pressure of the compressor; and
outputting, by the computer system, an indication of the remaining useful life of the filter.

2. The method of claim 1,
wherein determining the remaining useful life of the filter comprises determining the remaining useful life of the filter according to the following equation:
$${Filter}_{life} = min ( 1 , 1 - \frac{{P}_{dis} - {P}_{disClean}}{{P}_{disClogged} - {P}_{disClean}} ) \times 100 \% ;$$
wherein:
Filter_{life} is the remaining useful life of the filter;
P_{dis} is the measured discharge pressure of the compressor;
P_{disClean} is the first predicted discharge pressure of the compressor; and
P_{disClogged} is the second predicted discharge pressure of the compressor.

3. The method of claim 1,
wherein each of the first reduced order model and the second reduced order model are of the following form:
P_{pred}=b₀+Σᵢbᵢxᵢ^{c}^{ᵢ}+Σⱼbⱼ(X)ⱼ^{c}^{ⱼ};
wherein:
P_{pred} is a predicted discharge pressure of the compressor;
b₀ is a constant;
bᵢ and bⱼ are multiplicative regression coefficients;
cᵢ and cⱼ are exponential regression coefficients;
xᵢ are first order parameters, each corresponding to one of the measured operational parameters; and
Xⱼ are interaction terms, each corresponding to a multiplicative product of two or more of the measured operational parameters.

4. The method of claim 3, further comprising:
selecting the first order parameters xᵢ from a set of candidate first order parameters and selecting the interaction terms Xⱼ from a set of candidate interaction terms based on determining that the first order parameters xᵢ and the interaction terms Xⱼ result in the predicted discharge pressure P_{pred} that is within a threshold deviation from a reference discharge pressure of the compressor.

5. The method of claim 1, further comprising:
generating the first reduced order model using a high-fidelity physics-based model of the vapor cycle refrigeration system having a simulated unclogged state of the filter; and
generating the second reduced order model using the high-fidelity physics-based model having a simulated clogged state of the filter.

6. The method of claim 1, further comprising:
generating the first reduced order model using first stored operational parameters of the vapor cycle refrigeration system that were stored during previous operation of the vapor cycle refrigeration system with the unclogged state of the filter; and
generating the second reduced order model using second stored operational parameters of the vapor cycle refrigeration system that were stored during previous operation of the vapor cycle refrigeration system with the clogged state of the filter.

7. The method of claim 1,
wherein the computer system is a remote, ground-based computer system.

8. The method of claim 1, further comprising:
receiving, by a controller device of the vapor cycle refrigeration system, a data upload request from a data acquisition system of an aircraft that includes the vapor cycle refrigeration system;
wherein transmitting the plurality of measured operational parameters to the computer system comprises:
transmitting the plurality of measured operational parameters from the controller device of the vapor cycle refrigeration system to the data acquisition system in response to receiving the data upload request; and
transmitting the plurality of measured operational parameters from the data acquisition system to the computer system.

9. The method of claim 1,
wherein the indication of the remaining useful life of the filter includes an indication of an estimated amount of remaining run-time of the vapor cycle refrigeration system before the remaining useful life of the filter reaches an unacceptable level.

10. The method of claim 1,
wherein the operational parameters include one or more of a compressor suction temperature, a compressor discharge temperature, a heat sink inlet temperature, a compressor suction pressure, a compressor discharge pressure, a compressor speed, and a compressor motor current draw.

11. A system comprising:
a vapor cycle refrigeration system of an aircraft, the vapor cycle refrigeration system comprising:
a plurality of sensors configured to measure operational parameters of the vapor cycle refrigeration system;
a compressor configured to compress refrigerant of the vapor cycle refrigeration system; and
a filter disposed within a flow path of the refrigerant; and
a computer system comprising:
at least one processor; and
computer-readable memory encoded with instructions that, when executed by the at least one processor, cause the computer system to:
receive the operational parameters of the vapor cycle refrigeration system measured by the plurality of sensors;
generate, using a first reduced order model that corresponds to an unclogged state of the filter, a first predicted discharge pressure of the compressor based on the received operational parameters;
generate, using a second reduced order model that corresponds to a clogged state of the filter, a second predicted discharge pressure of the compressor based on the received operational parameters;
determine a remaining useful life of the filter based on the first predicted discharge pressure, the second predicted discharge pressure, and a measured discharge pressure of the compressor; and
output an indication of the remaining useful life of the filter.

12. The system of claim 11,
wherein the computer system is encoded with instructions that, when executed by the at least one processor, cause the computer system to determine the remaining useful life of the filter according to the following equation:
$${Filter}_{life} = min ( 1 , 1 - \frac{{P}_{dis} - {P}_{disClean}}{{P}_{disClogged} - {P}_{disClean}} ) \times 100 \% ;$$
wherein:
Filter_{life} is the remaining useful life of the filter;
P_{dis} is the measured discharge pressure of the compressor;
P_{disClean} is the first predicted discharge pressure of the compressor; and
P_{disClogged} is the second predicted discharge pressure of the compressor.

13. The system of claim 11,
wherein each of the first reduced order model and the second reduced order model are of the following form:
P_{pred}=b₀+Σᵢbᵢxᵢ^{c}^{ᵢ}+Σⱼbⱼ(X)ⱼ^{c}^{ⱼ};
wherein:
P_{pred} is a predicted discharge pressure of the compressor;
b₀ is a constant;
bᵢ and bⱼ are multiplicative regression coefficients;
cᵢ and cⱼ are exponential regression coefficients;
xᵢ are first order parameters, each corresponding to one of the measured operational parameters; and
Xⱼ are interaction terms, each corresponding to a multiplicative product of two or more of the measured operational parameters.

14. The system of claim 13,
wherein the computer-readable memory is further encoded with instructions that, when executed by the at least one processor, cause the computer system to select the first order parameters xᵢ from a set of candidate first order parameters and select the interaction terms Xⱼ from a set of candidate interaction terms based on determining that the first order parameters xᵢ and the interaction terms Xⱼ result in the predicted discharge pressure P_{pred} that is within a threshold deviation from a reference discharge pressure of the compressor.

15. The system of claim 11,
wherein the computer-readable memory is further encoded with instructions that, when executed by the at least one processor, cause the computer system to:
generate the first reduced order model using a high-fidelity physics-based model of the vapor cycle refrigeration system having a simulated unclogged state of the filter; and
generate the second reduced order model using the high-fidelity physics-based model having a simulated clogged state of the filter.

16. The system of claim 11,
wherein the computer-readable memory is further encoded with instructions that, when executed by the at least one processor, cause the computer system to:
generate the first reduced order model using first stored operational parameters of the vapor cycle refrigeration system that were stored during previous operation of the vapor cycle refrigeration system with the unclogged state of the filter; and
generate the second reduced order model using second stored operational parameters of the vapor cycle refrigeration system that were stored during previous operation of the vapor cycle refrigeration system with the clogged state of the filter.

17. The system of claim 11,
wherein the computer-system is a remote, ground-based computer system.

18. The system of claim 11,
wherein the vapor cycle refrigeration system further comprises:
a controller device operatively connected to the plurality of sensors and to a data acquisition system of the aircraft; and
wherein the controller device is configured to transmit the operational parameters of the vapor cycle refrigeration system measured by the plurality of sensors to the data acquisition system in response to receiving a data upload request from the data acquisition system.

19. The system of claim 11,
wherein the computer system is further encoded with instructions that, when executed by the at least one processor, cause the computer system to determine an estimated amount of remaining run-time of the vapor cycle refrigeration system before the remaining useful life of the filter reaches an unacceptable level.

20. The system of claim 11,
wherein the plurality of sensors include one or more of a compressor suction temperature sensor, a compressor discharge temperature sensor, a heat sink inlet temperature sensor, a compressor suction pressure sensor, a compressor discharge pressure sensor, a compressor speed sensor, and a compressor motor current sensor.
